(19) United States
(12) Patent Application Publication
(10) Pub. No.: US 2015/0371356 A1
(43) Pub. Date: Dec. 24, 2015

(54) Phone Display Enhancing Connection Device

(71) Applicant: James R. McMullen, Mooresville, NC (US)

(72) Inventor: James R. McMullen, Mooresville, NC (US)

(21) Appl. No.: 14/310,519

(22) Filed: Jun. 20, 2014

(51) Int. Cl. G06T 1/20

(52) U.S. Cl. CPC G06T 1/20

(57) ABSTRACT

A phone display enhancing connection device connects a phone to an extrinsic electronic device having a larger display screen. The device includes a cord having a first end for electronic coupling to a phone and a second end for electronic coupling to an extrinsic electronic apparatus having a display screen larger than a display screen of the phone. A housing is positioned between a first section of the cord and a second section of the cord. A processor positioned in the housing is communicatively coupled between the first end of the cord and the second end of the cord. The processor has translation programming wherein the processor is configured to translate communications between the phone and the extrinsic electronic apparatus for displaying images from the phone on the extrinsic electronic apparatus and controlling the phone using the extrinsic electronic apparatus.

### BACKGROUND OF THE DISCLOSURE

### Field of the Disclosure

The disclosure relates to connection devices and more particularly pertains to a new connection device for connecting a phone to an extrinsic electronic device having a larger display screen and providing a processor and programming in the connection device to facilitate communication with and control of the phone by manipulation of the larger display screen.

### SUMMARY OF THE DISCLOSURE

An embodiment of the disclosure meets the needs presented above by generally comprising a cord having a first end for electronic coupling to a phone and a second end for electronic coupling to an extrinsic electronic apparatus having a display screen larger than a display screen of the phone. A housing is positioned between a first section of the cord and a second section of the cord. A processor positioned in the housing is communicatively coupled between the first end of the cord and the second end of the cord. The processor has translation programming wherein the processor is configured to translate communications between the phone and the extrinsic electronic apparatus for displaying images from the phone on the extrinsic electronic apparatus and controlling the phone using the extrinsic electronic apparatus.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a phone display enhancing connection device according to an embodiment of the disclosure.

FIG. 2 is a front view of a variety of connectors for various embodiments of the disclosure.

FIG. 3 is a schematic view of an embodiment of the disclosure.

### DESCRIPTION OF THE PREFERRED EMBODIMENT

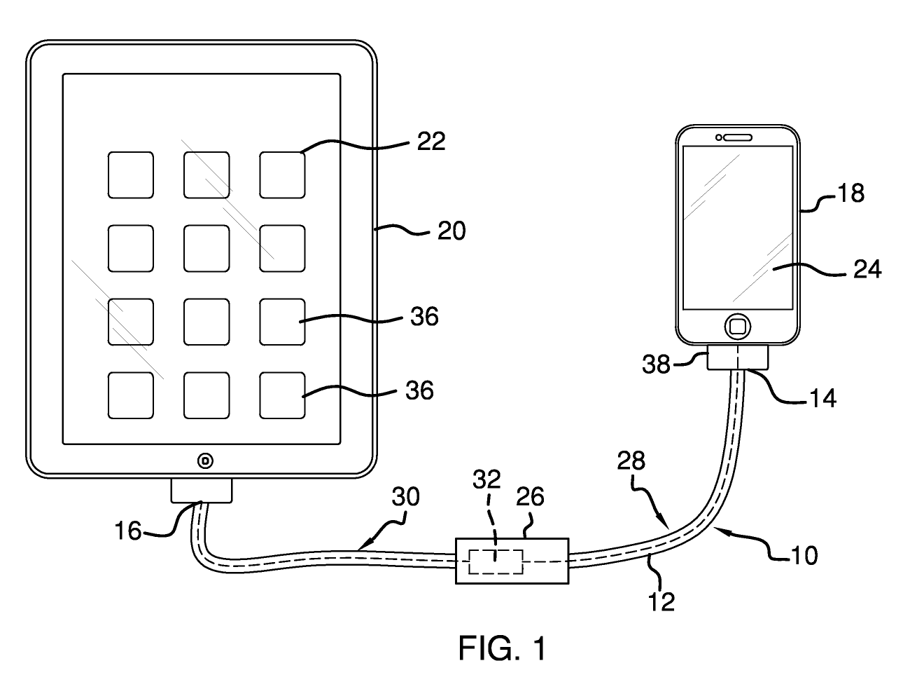

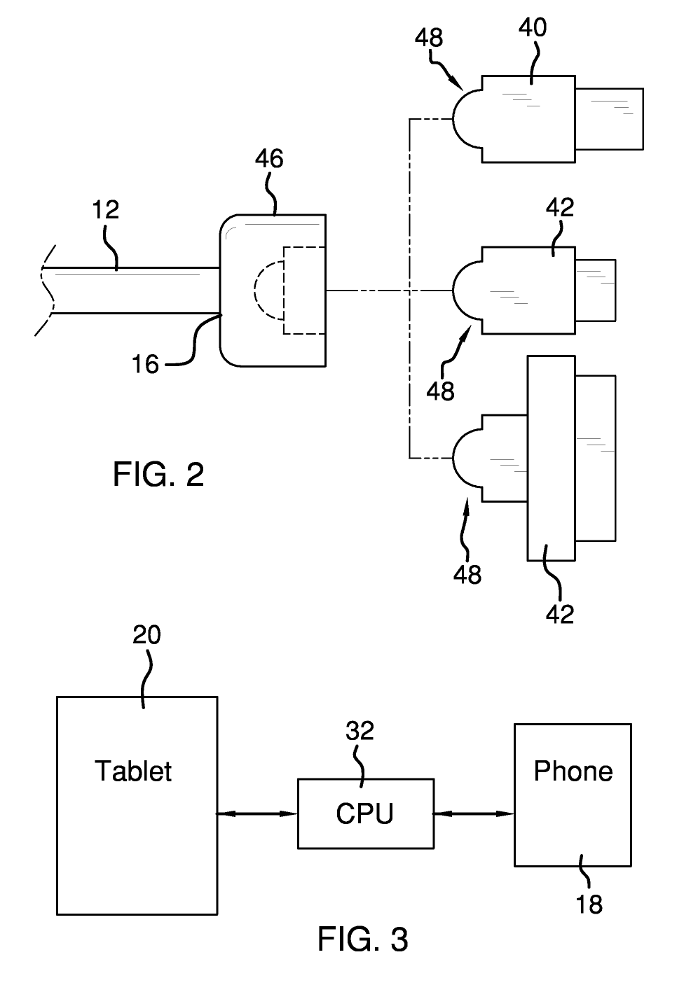

With reference now to the drawings, and in particular to FIGS. 1 through 3 thereof, a new connection device embodying the principles and concepts of an embodiment of the disclosure and generally designated by the reference numeral 10 will be described.

As best illustrated in FIGS. 1 through 3, the phone display enhancing connection device 10 generally comprises a cord 12 having a first end 14 and a second end 16. The first end 14 is configured for electronic coupling to a phone 18. The second end 16 is configured for electronic coupling to an extrinsic electronic apparatus 20 such as a tablet, laptop computer, or the like. The extrinsic electronic apparatus 20 has a display screen 22 larger than a display screen 24 of the phone 18.

A housing 26 is coupled to the cord 12. The housing 26 is positioned between a first section 28 of the cord 12 and a second section 30 of the cord 12. A processor 32 is positioned in the housing 26. The processor 32 is communicatively coupled between the first end 14 of the cord 12 and the second end 16 of the cord 12. The processor 32 has translation programming wherein the processor 32 is configured to translate communications between the phone 18 and the extrinsic electronic apparatus 20 such that images from the phone 18 are displayed on the extrinsic electronic apparatus 20 and control of the extrinsic electronic apparatus 20 by manipulation of inputs 36 on the extrinsic electronic apparatus 20 controls functions of the phone 18. A phone connection plug 38 of conventional design is coupled to the first end 14 of the cord 12. One of a universal serial bus connector 40 and an electronic tablet connector 42 is coupled to the second end 16 of the cord 12. A socket 46 and a variety of plugs 48 may be coupled to the second end 16 of the cord 12 allowing various devices to connect to and control the phone 18 using the cord 12.

In use, the phone 18 is controlled by use of the extrinsic electronic apparatus 20 through the cord 12. The processor 32 provides intercommunication between the phone 18 and the extrinsic electronic apparatus 20 of different types, brands, or configurations otherwise unsuited for direct communication.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A phone display enhancing connection device comprising:
a cord having a first end and a second end, said first end being configured for electronic coupling to a phone, said second end being configured for electronic coupling to an extrinsic electronic apparatus having a display screen larger than a display screen of the phone;
a housing coupled to said cord, said housing being positioned between a first section of said cord and a second section of said cord; and
a processor positioned in said housing, said processor being communicatively coupled between said first end of said cord and said second end of said cord, said processor having translation programming wherein said processor is configured to translate communications between the phone and the extrinsic electronic apparatus wherein images from the phone are displayed on the extrinsic electronic apparatus and control of the extrinsic electronic apparatus controls functions of the phone.

2. The device of claim 1, further comprising a phone connection plug being coupled to said first end of said cord.

3. The device of claim 1, further comprising a universal serial bus connector coupled to said second end of said cord.

4. The device of claim 1, further comprising an electronic tablet connector coupled to said second end of said cord.

5. A phone display enhancing connection device comprising:
a cord having a first end and a second end, said first end being configured for electronic coupling to a phone, said second end being configured for electronic coupling to an extrinsic electronic apparatus having a display screen larger than a display screen of the phone;
a housing coupled to said cord, said housing being positioned between a first section of said cord and a second section of said cord;
a processor positioned in said housing, said processor being communicatively coupled between said first end of said cord and said second end of said cord, said processor having translation programming wherein said processor is configured to translate communications between the phone and the extrinsic electronic apparatus wherein images from the phone are displayed on the extrinsic electronic apparatus and control of the extrinsic electronic apparatus controls functions of the phone;
a phone connection plug being coupled to said first end of said cord; and
one of a universal serial bus connector and an electronic tablet connector being coupled to said second end of said cord.
